(19) United States
(12) Patent Application Publication
(10) Pub. No.: US 2016/0006986 A1
(43) Pub. Date: Jan. 7, 2016

(54) SPEECH RATE MANIPULATION IN A VIDEO CONFERENCE

(71) Applicant: Polycom, Inc., San Jose, CA (US)

(72) Inventor: Santhoshkumar Settipalli, Tiptur (IN)

(21) Appl. No.: 14/790,151

(22) Filed: Jul. 2, 2015

(30) Foreign Application Priority Data
Jul. 2, 2014 (IN) 725/KOL/2014

(51) Int. Cl. H04N 7/15

(52) U.S. Cl. CPC H04N 7/155

(57) ABSTRACT

A method and system for modifying playback in a media conference, including receiving, during a media conference, an instruction to delay an audio feed of the conference at a first endpoint, where the conference includes the local endpoint and remote endpoints, and delaying the audio feed at the local endpoint, including storing the audio feed to a buffer in real time, and modifying a playback of the audio feed at the local endpoint from the buffer, where the audio feed to the plurality of remote endpoints remains unaffected by the delay at the first endpoint.

### CROSS REFERENCE TO RELATED APPLICATIONS

This application claims priority to Indian Provisional Application No. 725/KOL/2014 filed Jul. 2, 2014, entitled “Speech Rate Manipulation in a Video Conference,” which is incorporated herein by reference in its entirety.

### FIELD OF THE INVENTION

The application relates generally to the field of audio conferencing and videoconferencing. More particularly, but not by way of limitation, to a method of managing the rate and latency of audio playback.

### BACKGROUND OF THE INVENTION

In modern business organizations it is not uncommon for groups of geographically diverse individuals to participate in a videoconference in lieu of a face-to-face meeting. Such videoconferences may comprise one or more participants in one location communicating with one or more participants in a second location. The increasing number of multinational companies and the rise in multinational trade make it more and more likely that audio and video conferences are conducted between participants in different countries.

Potential problems arise when there are differences in language fluency between participants at endpoints in different countries. These differences can become significant barriers to effective communication. Participants who have heavy accents tend to exacerbate the problem. What is needed is a way to slow down the conversation in a live audioconference or videoconference so that a person who has difficulty understanding a speaker has a better chance to understand what is being said in the conference and contributing to the conference.

### BRIEF DESCRIPTION OF THE DRAWINGS

FIG. 1 shows an example videoconferencing component diagram of a multi-location videoconference system.

FIG. 2 shows an example audio/video receiver system in accordance with an embodiment of the disclosure.

FIG. 3 is a diagram showing the time expansion and latency between slowed replay and real-time play of an audio or video signal.

FIG. 4 shows examples of time stretched and non-stretched audio waveforms.

FIG. 5 shows an example of signal-to-noise and threshold analysis with respect to the waveforms in FIG. 4.

FIG. 6 shows a control panel in accordance with an embodiment of the present disclosure.

### DETAILED DESCRIPTION

As previously noted, differences in languages may cause barriers to communication. Disclosed is a mechanism to play the audio and/or video of an audio or videoconference at a slower speed. Participants who do not understand what is being said in the conference may remain silent when the conversation is moving too fast. This may leave participants feeling disconnected and less likely to contribute to the conference. Such participants may wait until the conference is over and then review a recording of the conference to pick up on things that went by too quickly during the live conference. This is also less desirable as contributions from these participants may be missed in the conference.

In one aspect of the present disclosure, a time-stretching filter to expand or compress replay times may be used to slow down the conversation on the receiving end so that the participant may hear the conversation at a slower pace than what is being captured at the transmitting end. A visual or tactile interface may be provided to allow a participant to speed-up, slow-down, catch-up, or review portions of the live or recorded videoconference. Additionally, the preferred settings for the time expansion or compression may be stored for individual or group participants and automatically

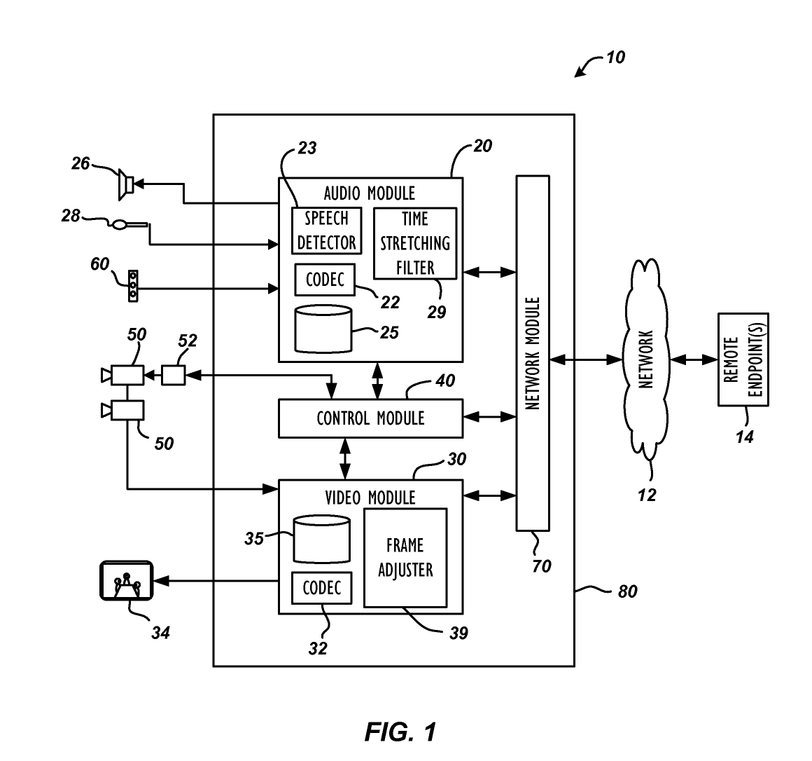

FIG. 1 shows a videoconferencing endpoint 10 in communication with one or more remote endpoints 14 over a network 12. The endpoint 10 can be a videoconferencing unit, speakerphone, desktop videoconferencing unit, etc. Among some common components, the endpoint 10 may have a videoconferencing endpoint unit 80 (e.g., a conference bridge) comprising an audio module 20 and a video module 30 operatively coupled to a control module 40 and a network module 70 for interfacing with the network 12.

The audio module 20 may comprise an audio codec 22 for processing (e.g., compressing, decompressing and converting) audio signals, a speech detector 43 for detecting speech and filtering out non-speech audio, and a time stretching filter 42, discussed further below, for expanding or compressing the audio playback. The audio module 20 may also comprise an audio buffer 25 memory that may store audio for playback. The audio buffer 25 memory may be stored on a storage device, which can be volatile (e.g., RAM) or non-volatile (e.g., ROM, FLASH, hard-disk drive, etc.).

The video module 30 may comprise a video codec 32 for processing (e.g., compressing, decompressing and converting) video signals, a frame adjuster module 44 for adding or subtracting video frames in order to speed-up or slow down the video playback. The video module 30 may also comprise a video buffer 35 memory that stores video for playback.

A control module 40 operatively coupled to the audio module 20 and the video module 30 may use audio and/or video information (e.g., from the speech detector 23, audio, or video inputs) to control various functions of the audio, video, and network modules. The control module 40 may also send commands to various peripheral devices such as camera aiming commands to cameras 50 to alter their orientations and the views that they capture. Control module may contain, or may be operatively connected to a storage device which stores historic data regarding user-manipulated settings for various media conferences. In one or more embodiment, control module 40 may determine that the local endpoint 10 is conferencing with one or more remote endpoints for which historic user-manipulated settings have been saved. The control module 40 may modify the various media streams, such as the audio stream or a video streams, based on stored settings associated with an identified remote endpoint that is taking part in the conference.

The network module 70 may be operatively coupled to the audio module 20, the video module 30, and the control module 40 for connecting the endpoint unit 80 to the network 12. The endpoint unit 80 may encode the captured audio and video using common encoding standards, such as MPEG-1, MPEG-2, MPEG-4, H.261, H.263, H.264, G.722, G.722.1, G.711, G.728, and G.729. The network module 70 may then output the encoded audio and video to the remote endpoints 14 via the network 12 using any appropriate protocol. Similarly, the network module 70 receives conference audio and video via the network 12 from the remote endpoints 14 and may send these to audio codec 22 and video codec 32 respectively for decoding and other processing. It should be noted that audio codec 22 and video codec 32 need not be separate and may share common elements.

The videoconferencing endpoint unit 80 may be connected to a number of peripherals to facilitate the videoconference. For example, one or more cameras 50 may capture video and provide the captured video to the video module 30 for processing. A camera control unit 52 having motors, servos, and the like may be used to mechanically steer the camera 50 (tilt and pan) and in some embodiments, may be used to control a mechanical zoom or electronic pan/tilt/zoom (ePTZ). Additionally, one or more microphones 28 may capture audio and provide the audio to the audio module 20 for processing. Microphones 28 can be table or ceiling microphones, for example, or part of a microphone pod (not shown).

Additionally, a microphone array 60 may also capture audio and provide the audio to the audio module 22 for processing. A loudspeaker 26 may be used to output conference audio, such as an audio feed, and a video display 34 may be used to output conference video, such as a video feed. Many of these modules and other components can be integrated or be separate, for example, microphones 28 and loudspeaker 26 may be integrated into one pod (not shown).

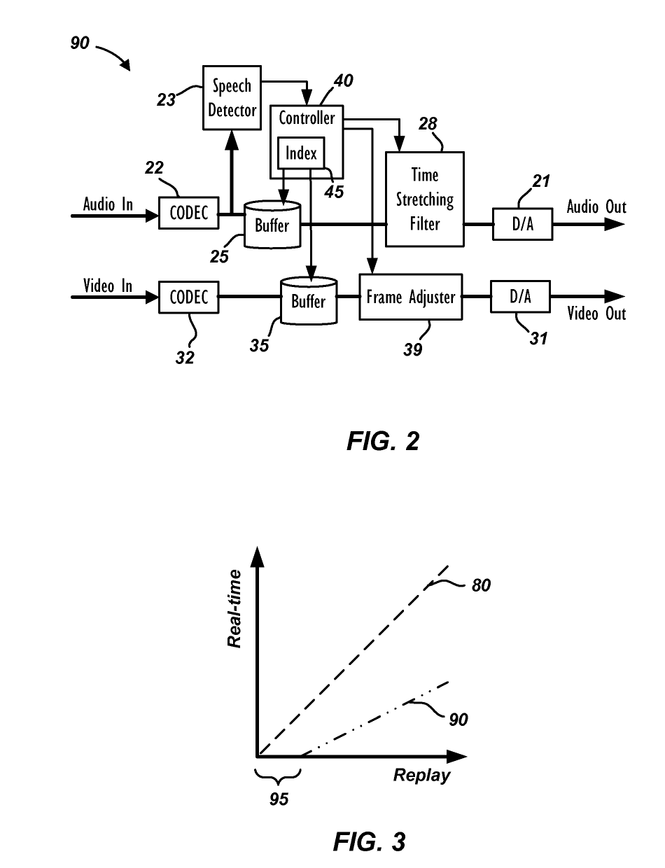

FIG. 2 shows a video and audio receiver 90 showing the data flow of the received audio and video in from the remote endpoints 14. Many of the blocks used in the receiver 90 have been described with respect to FIG. 1 and need not be re-described. Additionally shown in FIG. 2, Digital-to-Analog converters 21, 31 (“DACs”) that convert the digital audio and video streams into analog, i.e., converted to a form that can be sent directly to speakers and a monitor. Also shown is the index module 45. The index module 45 is used as a pointer into the audio buffer 25 and the video buffer 35. Since audio and video are usually run at different frame rates, a separate index is supplied to each buffer. For example, audio sampled at 22 k samples/second and video at 60 frames/second may be sent to the receiver. In this case, for a buffer index of one second, the audio would be indexed to the 22,000th sample while the video index would point to the 60th frame.

FIG. 3 illustrates the video and audio signal replay related to playing time. The line 80 represents a zero temporal distortion with no time compression or expansion. In other words, for every one second of video and audio data that is sent to the receiver 90, one second of video and audio data is output to the DACs 21, 31. This represents the situation where the time stretching filter 28 and the frame adjuster 39 are turned off or bypassed.

In order to slow the audio that the local participant hears from the remote endpoints 14, the slope of the line must be decreased. That is, for every second of realtime data received, greater than one second of data is output to the DACs 21, 31 as shown in line 90. It is preferred that the time stretching filter 28 not only stretch out the audio signal in time so that words appear to be spoken more slowly, but the filter 28 should preserve pitch and timbre as well. This increases the intelligibility of the voice as well as preserves the personal voice qualities of the speaking participant. A number of filtering techniques are known in the art for accomplishing this, for example a Pitch Synchronous Overlap Add (PSOLA) filter may be used to modify time-scale and pitch scale so that the speech is longer in duration but maintains its normal speaking pitch and timbre.

Using this technique can result in a loss of data if not otherwise preserved. To prevent data loss, buffers 25, 35 are used to store the audio and video data as it comes in (i.e., in real time). A time lag 95 is generated between the output as heard by the local participants and the real-time conference audio as the time stretching filter 28 expands the output. For example, if the time stretching filter 28 is configured to replay at half the speed of the incoming conference audio, then 30 seconds of lag will develop for every minute of conference time. However, after ten minutes of listening to the conference at the slower rate, in this example, five minutes of lag could have developed and the remote participants may have moved on to a new subject.

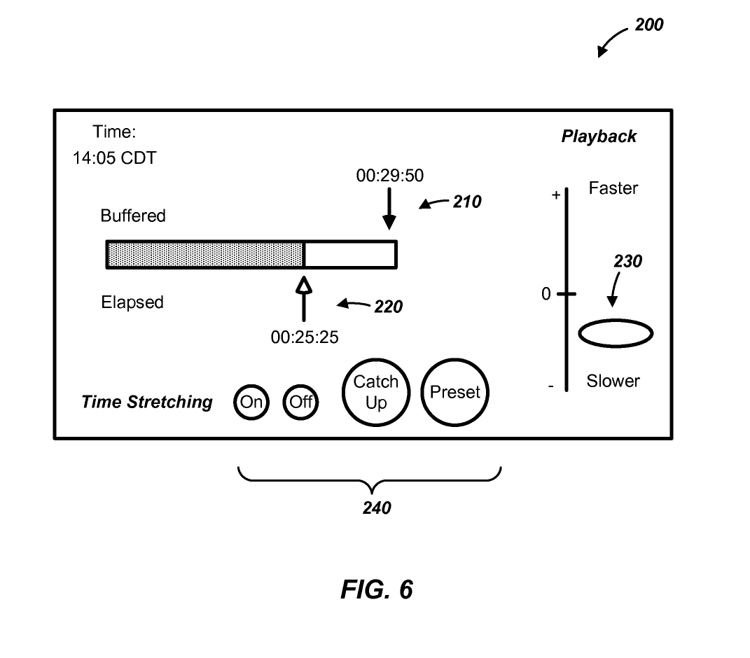

The listening participant may choose to “catch-up” in order to participate in the conference by selecting a catch-up button 240 or advancing an elapsed time indicator 220 to the end of the buffered data (discussed below with reference to FIG. 6). That is, the user may accelerate the audio feed after it has been delayed. But this may result in the local participant missing out on five minutes of conference.

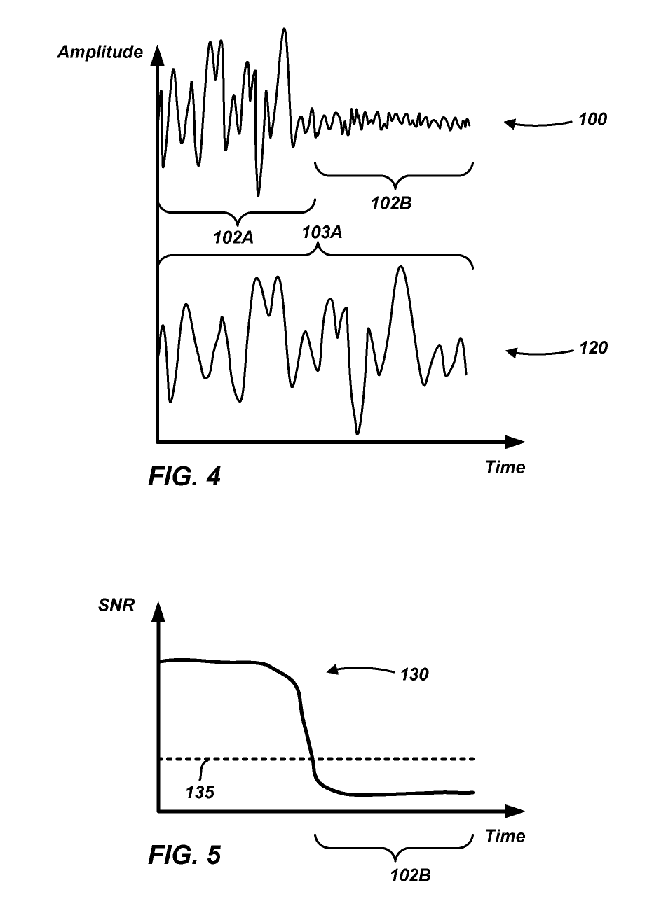

One technique to help alleviate the build-up of lag time while listening to slowed audio can be best understood with reference to FIGS. 4 & 5. FIG. 4 shows a real-time audio waveform 100 from a remote endpoint above an expanded audio waveform 120 played at a local endpoint. During a conference, a speaking participant may talk for a speaking period 102A. However, natural lulls 102B in conversation generate periods of relative silence. For example, lull 102B may occur when a speaker pauses to collect their thoughts or after a speaker asks a rhetorical question.

In the example shown in FIG. 4, the lull time 102B plus the speaking period 102A equals the expanded time 103A that was used to output the expanded speaking period 102A. Speech detector 23 can be used to detect lulls 102B in conversation. The controller 40 may then advance the index 45 for an appropriate number of samples once the time stretched audio reaches the same sample as the beginning of the lull 102B. A number of techniques may be used to detect the lull 102B. For instance, a voice activity detector as further described in co-owned U.S. Pat. No. 6,453,285 entitled “Speech activity detector for use in noise reduction system, and methods therefor” which is hereby incorporated by reference, may be used as speech detector 23.

Additionally, as shown in FIG. 5, a signal-to-noise ratio (SNR) 130 may be calculated on the real-time waveform 100 and a threshold 135 used to determine lulls 102B. This will reduce the total lag 95 experienced by participants.

To keep the video and the stretched audio in synchronization, a frame adjuster 39 may be used to speed-up or slow down the video signal such that the video keeps pace with the stretched audio. Frame adjuster 39 may insert duplicate frames or remove frames as needed. For example, when slowed down to half speed, frame adjuster 39 inserts duplicate frames for every frame present.

Another technique for keeping the video and audio in synchronization when listening to the time-stretched audio is where the frame rate of the video DAC 31 is slowed by the proportional rate as the audio is being slowed.

FIG. 6 shows a user interface 200, that may be used to set and modify some of the parameters previously described herein. The interface 200 may be implemented as a touch-screen, clickable, or selectable graphical user interface, for example, or may be an interface with physical buttons and sliders. As shown, a slider 230 allows a participant to slow-down or speed up the audio and video as presented from a remote endpoint. A display 210 indicates the total current running time of the conference (recorded and buffered) and slider 220 indicates where in the conference allows a user to select anywhere in the recorded and buffered conference. Slider 220 may also indicate how much of the conference is recorded versus what has been played back. Control buttons 240 may allow a user to activate, de-activate, catch-up, pause (not shown), and record settings for preset.

So a user does not need perform the strenuous task and endure a bad user-experience of making adjustments to the speech rate for every call based on the person with whom the current user is communicating with would be, an automated method is provided.

An analytic such as identifying for what participants the current user modifies the speech rate and what rate is set most of the time may be used to automatically adjust the speech rate when the current user is in conversation with specific parties.

A database (not shown), for example a NoSQL, SQL, or any key-value based file structure solution like Cassandra, MongoDB, or CouchBase, may capture the participant details and the current speech rate chosen by the user. This database can be embedded in a hardware phone or can be located in a server to which the phone is connected to. In case the mechanism to capture the required data is located in the server, then the phone could have a mechanism to push periodic updates on the user activity with respect to the speech rate changes to the server.

A pattern of speech rates utilized by the user, based on specific participants on the other end of the call may be determined by executing batch-processing queries of the server data and periodically analyzing the data. This can be further extended to complicated scenarios like meetings where there are multiple participants and details of each and specific participant has to be captured analyzed and later utilized to adjust speech rate automatically when the same set of participants are in conversation.

Note that elements of the audio and video receiver 90 may be encompassed in a separate module (not shown) as an external add-on to legacy systems. Also, although generally discussed with reference to videoconferencing, one skilled in the art will readily recognize the applicability of the disclosed techniques to audio only conferences.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

We claim:

1. A method for modifying playback in a media conference, comprising:
receiving, during a media conference, an instruction to delay an audio feed of the conference at a first endpoint, wherein the conference includes the local endpoint and a plurality of remote endpoints;
delaying the audio feed at the local endpoint, comprising:
storing the audio feed to a buffer in real time, and
modifying a playback of the audio feed at the local endpoint from the buffer, wherein the audio feed to the plurality of remote endpoints remains unaffected by the delay at the first endpoint.

2. The method of claim 1, further comprising:
receiving an instruction to accelerate the delayed audio feed of the conference at the first endpoint; and
accelerating the audio feed of the conference at the first endpoint, wherein the audio feed to the plurality of remote endpoints remains unaffected by the acceleration at the first endpoint.

3. The method of claim 2, wherein delaying the audio feed comprises decreasing a time scale of the audio feed to a modified rate, and wherein accelerating the audio feed comprises increasing the time scare of the audio feed from the modified rate.

4. The method of claim 2, wherein accelerating the audio feed comprises:
identifying one or more lull periods in the audio feed stored on the audio buffer; and
modifying the playback from the audio buffer to omit the one or more lulls.

5. The method of claim 1, wherein delaying the audio feed comprises applying an audio filter, wherein the audio filter modifies a time scale of the audio feed to be longer in duration than the original audio feed, and wherein the audio filter modifies the pitch scale of the audio feed such that the pitch of the modified audio feed is substantially similar to the unmodified audio feed.

6. The method of claim 1, further comprising:
in response to delaying the audio feed, modifying a video feed corresponding to the audio feed to delay the video feed at a same rate as the delay of the audio feed.

7. The method of claim 6, wherein modifying the video feed comprises slowing a frame rate of the video feed by a proportional rate as the delay of the audio feed.

8. A system for modifying playback in a media conference, comprising:
a local endpoint, comprising an audio module and operatively connected to a control module for interfacing with a plurality of remote endpoints, the local endpoint configured to:
receive, during a media conference, an instruction to delay an audio feed of the conference at a first endpoint, wherein the conference includes the local endpoint and a plurality of remote endpoints; and
delay the audio feed at the local endpoint, comprising:
storing the audio feed to a buffer in real time, and
modifying a playback of the audio feed at the local endpoint from the buffer, wherein the audio feed to the plurality of remote endpoints remains unaffected by the delay at the first endpoint.

9. The system, the local endpoint further configured to:
receive an instruction to accelerate the delayed audio feed of the conference at the first endpoint; and
accelerate the audio feed of the conference at the first endpoint, wherein the audio feed to the plurality of remote endpoints remains unaffected by the acceleration at the first endpoint.

10. The system of claim 9, wherein delaying the audio feed comprises decreasing a time scale of the audio feed to a modified rate, and wherein accelerating the audio feed comprises increasing the time scare of the audio feed from the modified rate.

11. The system of claim 9, wherein accelerating the audio feed comprises:
identifying one or more lull periods in the audio feed stored on the audio buffer; and
modifying the playback from the audio buffer to omit the one or more lulls.

12. The system of claim 8, wherein delaying the audio feed comprises applying an audio filter, wherein the audio filter modifies a time scale of the audio feed to be longer in duration than the original audio feed, and wherein the audio filter modifies the pitch scale of the audio feed such that the pitch of the modified audio feed is substantially similar to the unmodified audio feed.

13. The system of claim 8, the local endpoint further configured to:
in response to delaying the audio feed, modify a video feed corresponding to the audio feed to delay the video feed at a same rate as the delay of the audio feed.

14. The system of claim 13, wherein modifying the video feed comprises slowing a frame rate of the video feed by a proportional rate as the delay of the audio feed.

15. A method for automatically customizing conference playback, comprising:
determining that a local endpoint is in a first media conference with a first remote endpoint;
identifying a first user-manipulated setting for an audio playback of the media conference;
storing, in a storage device, the first user-manipulated settings for the audio playback as associated with the first remote unit;
determining that the local endpoint and the first remote endpoint are engaged in a second media conference;
in response to determining that the local endpoint and the first remote endpoint are engaged in a second audio conference:
retrieving the first user-manipulated settings associated with the first remote endpoint, and
automatically setting current playback settings of the audio conference to the first user-manipulated settings, wherein the playback settings of the local endpoint do not affect the first remote endpoint.

16. The method of claim 15, further comprising:
in response to determining that the local endpoint and the first remote endpoint are engaged in the second audio conference with a second remote endpoint:
retrieving, from the storage device, second user-manipulated settings associated with the second remote endpoint, and
automatically setting current playback settings of the audio conference to the first user-manipulated settings when a user at the first remote device is speaking, and to the second user-manipulated settings when a user at the second endpoint is speaking.

17. The method of claim 15, wherein the first user-manipulated settings comprises delaying an audio feed of the first audio conference, and wherein delaying the audio feed comprises:
storing the audio feed to a buffer in real time; and
modifying a playback of the audio feed at the local endpoint from the buffer.

18. The method of claim 17, wherein delaying the audio feed comprises applying an audio filter, wherein the audio filter modifies a time scale of the audio feed to be longer in duration than the original audio feed.

19. The method of claim 17, further comprising:
in response to delaying the audio feed, modifying a video feed corresponding to the audio feed to delay the video feed at a same rate as the delay of the audio feed.

20. The method of claim 15, wherein identifying a first user-manipulated setting for an audio playback of the media conference comprises capturing a modified speech rate of an audio feed of the first audio conference.
